(19) United States
(12) Patent Application Publication
(10) Pub. No.: US 2015/0204299 A1
(43) Pub. Date: Jul. 23, 2015

(54) GENERATION OF POWER FROM RIVERS AND THE LIKE

(71) Applicant: Peter A. Jones, Saint John (CA)

(72) Inventor: Peter A. Jones, Saint John (CA)

(21) Appl. No.: 14/378,721

(22) PCT Filed: Feb. 15, 2013
(86) PCT No.: PCT/CA2013/050119

§ 371 Date: Aug. 14, 2014

Related U.S. Application Data
(60) Provisional application No. 61/599,978, filed on Feb. 17, 2012.
(60) Provisional application No. 61/724,335, filed on Nov. 9, 2012.

(51) Int. Cl. F03B 7/00; F03B 13/00

(52) U.S. Cl. CPC F03B 7/003; F03B 13/00

(57) ABSTRACT

Exemplary embodiments of the invention provide an apparatus and method for generating power from a renewable source of environmental water. The apparatus includes an upstanding structure adapted for support on ground adjacent to the renewable source of water having an elevated region relative to the ground. A conduit for water extends between the elevated region of the water supply and a water inlet. A gravity-operated energy converter supported by the structure is provided that causes water to descend vertically between the inlet and an outlet adjacent the ground while utilizing the weight of the water thus descending to drive at least one movable element and thereby produce power. Additional energy may be provided from buoyancy by causing empty and inverted water containers to ascend through a column of water fed by the renewable source of water.

### BACKGROUND OF THE INVENTION

1. Field of the Invention

This invention relates to the generation of power from water flowing in rivers, streams, brooks, and other renewable sources of water. More particularly, the invention relates to the generation of electricity from such sources.

2. Background of the Invention

Power has been generated from rivers and other natural sources of flowing water for many generations. For example, water wheels have been used for powering machinery during the industrial revolution. However, such power generation has normally relied on the movement of the water, i.e. the momentum of the water as it flows generally horizontally along a water course such as a river bed. More recently, electricity has been generated by building dams across rivers to form reservoirs and feeding the water from the reservoirs through passages to turbines, but again use is made of the momentum of water moving through the passages generally at high speed and under high pressure. Dams and the associated equipment are extremely expensive to build and the creation of reservoirs has involved the flooding of otherwise useful land and damage to flora and fauna.

Recently, as the price of fossil fuels has increased and locations for new dams and reservoirs has declined, there is a need to generate power in new ways, particularly ways that are environmentally benign and that employ sources of power that are continuously renewable. Power generated from wind energy has become popular, but winds do not blow constantly, so the equipment often stands idle for long periods of time or can be damaged during storms. Furthermore, wind turbines are frequently unpopular because they can be visually unappealing and noisy. The generation of electricity from solar energy has also become popular, but can only be carried out during the day, or when clouds are absent, so again there are long periods when the equipment is idle.

It would therefore be desirable to provide means to generate power, particularly electrical energy, from more reliable and readily available sources, such as rivers, while avoiding the disadvantages of prior known approaches.

### SUMMARY OF THE EXEMPLARY EMBODIMENTS

The present invention makes use of the weight of water and/or buoyancy (weight of water displaced) to generate energy, particularly in the form of electricity.

One exemplary embodiment of the present invention provides an apparatus for generating power from a source of water. The apparatus includes an upstanding structure adapted for support on ground adjacent to a renewable supply of water having an elevated region relative to the ground, the structure having a water inlet at a height no higher than the elevated region of the supply of water and a water outlet at a lower position than the inlet; a conduit for water extending between the elevated region of the water supply and the water inlet; and a gravity-operated energy converter supported by the structure that causes water to descend vertically between the horizontal levels of the inlet and the outlet while utilizing weight of the water thus descending to drive at least one movable element and thereby produce power.

The upstanding structure may be any kind of support for the operational elements of the energy converter. For example, in one embodiment, it may be a vertical post or wall embedded in the ground at its lower end, or in another embodiment, it may be a housing, such as a building, silo, hangar or the like intended both to shelter the operational elements and to provide support for them. In those cases where the structure is a building, it may be a prefabricated structure having its own foundations or designed for foundations provided at the site, or it may be a custom-built structure made of brick, concrete, wood, metal or other construction materials assembled at the site. Whatever the structure, adequate support for it should be provided by the ground so that the operational elements are securely held.

The conduit used to convey water to the structure may be of any suitable kind, e.g. a pipe, open-topped channel, flexible hose or duct, rigid aqueduct, or the like, and it may be made of any suitable material, e.g. plastics, brick, concrete, wood, metal, etc.

The gravity-operated energy converter is any machine, engine or motor that is capable of converting potential energy of water into kinetic energy, e.g. the movement of a movable element(s), e.g. the descent of water containers, the rotation of a shaft, the rotation of a rotor of a hydraulic motor, or the like. The kinetic energy can then be used for the generation of electricity by operation of a suitable electrical generator. Preferably, the movements of the movable element are passed through a gearbox or the like before connection to a generator in order to change the ratio of speeds of movement. Generally, the gearbox is used to increase the rate of movement to suit the input requirements of the generator. The gearbox and the generator may act as a brake or governor on the speed of movement of the movable element(s), which may be desirable to allow adequate use of available water supplies.

In a particular embodiment, the energy converter includes an upper generally horizontal rotatable shaft, a lower generally horizontal rotatable shaft positioned at a distance vertically below the upper shaft, at least one endless flexible band (and preferably two) passing around the shafts and a plurality of water containers supported at intervals along the bands, each container having an open end orientated to receive water from the conduit at the water inlet, with the containers acting as the at least one movable element. The flexible band may be in the form of an endless flexible chain engaging a sprocket wheel fixed on each of the upper and lower rotatable shafts.

The water containers may be elongated boxes that are held generally horizontal by the flexible band or bands, the open ends of the containers being at the tops of the boxes on one side of a vertical loop formed by the band or bands, and at the bottom of the boxes on an opposite side of the loop.

One of the upper rotatable shaft and the lower rotatable shaft may be driven by the flexible band or bands and may be used to transfer movement of the at least one movable element.

In another exemplary embodiment, the energy converter may include a water tank fed with water at a top thereof via the water inlet and feeding water at a bottom thereof to the water outlet, the energy converter including a hydraulic motor at or near the bottom of the tank and the at least one movable element comprises a rotor within the hydraulic motor driven by water passing between the tank to the water outlet.

In the exemplary embodiments, the renewable supply of water may be any natural or artificial supply of water, e.g. a river, stream or brook.

According to another exemplary embodiment, the invention provides a method of generating power from a renewable supply of water having ground adjacent thereto and a region of the water supply elevated relative to the adjacent ground. The method comprises: channeling water from the elevated region of the water supply to a position above the adjacent ground; causing the water to descend generally vertically (and ideally precisely vertically) from the position above the ground to a lower position adjacent to the ground; and utilizing weight of the water to drive at least one movable element as the water descends, and thereby converting gravity-based power of the water to movement of the at least one movable element.

Yet another exemplary embodiment relates to the gravity-operated energy converter of the above apparatus.

In particular embodiments, use is made of buoyancy, an upward force, to complement the use of weight, a downward force, in moving the movable element for the generation of energy. In one form, open-topped containers for holding water are, after their descent under gravity, emptied, inverted and introduced at the bottom of a column of water so that they generate a buoyancy force based on displaced water as they are caused to ascend. Both the weight and the buoyancy forces are harnessed to generate energy. More particularly, this may be achieved in a form of the invention in which containers are rotated about a vertical loop-like path with the containers being filled with water on the descending side of the loop and empty containers rise on the ascending side of the loop. Two adjacent vertical passageways may be provided, one for the descending containers and the other for the ascending containers. The ascending shaft is filled with water from the renewable source. A pair of dams operating in concert form a water-lock system at the lower end of the ascending passageway to retain water within the passageway while allowing empty and inverted containers to enter at the bottom of the ascending passageway. The top of the ascending passageway may be open to allow the empty containers to invert themselves again and return to the descending passageway.

The exemplary embodiments of the present invention may have the advantage that many readily available renewable sources of water may be utilized for energy generation without substantial capital outlay and destruction of the environment. Sources of water having relatively small volumes of flow may be utilized and the generated power may be fairly unaffected by differences of such volumes over time. Moreover, power may be generated constantly over a full 24 hour period without change. Nevertheless, if available volumes of flow fall below suitable limits for adequate power production over short periods of time, other sources of water (e.g. city water) may be used to fill the gap on a temporary basis.

The exemplary embodiments have the advantage that the apparatus may have a very small horizontal “footprint”, i.e. compared for example to a water wheel where the water is caused to move both horizontally as well as vertically (i.e. in an arc) as it descends, the apparatus may occupy a very limited horizontal area since the water descends vertically. To limit the horizontal footprint of the apparatus even further, an “elevator car” type of apparatus may be employed in which a container is filled with water at the top of a shaft or other support structure, allowed to descend suspended by cables, chains or bands connected to a generator of electricity, emptied at the bottom of the shaft, and then lifted by an electric motor once more via the same cables, chains or bands to the top of the shaft. The energy generated by the descent of the full container will clearly be much more than the energy required to raise the empty container. Since the empty container is raised vertically along the same trajectory as the descending full container, the footprint of such apparatus may be little more than the horizontal extend of the container itself. This exemplary embodiment is also of value when the rate of flow of water to the generating apparatus is slow or of low volume since the empty container at the top of the shaft may be kept in place long enough to fill completely, then the water supply may be held back by a simple movable dam or other water gate as the container descends, empties and then ascends back to the starting position.

### BRIEF DESCRIPTION OF THE DRAWINGS

FIG. 1 is a side view of a river flowing passing across a slope in the landscape creating rapids, and an illustration of apparatus according to one exemplary embodiment of the present invention;

FIG. 2 is an end view of equipment used in the exemplary embodiment of FIG. 1;

FIG. 3 is a partial view of the equipment of FIG. 2 shown in perspective;

FIGS. 4A and 4B are side views partially in cross section of another exemplary embodiment of the invention showing two different stages of operation of the apparatus;

FIG. 5 is a view similar to FIG. 2 of a further exemplary embodiment of the invention; and

FIG. 6 is a view similar to FIG. 2 showing a still further exemplary embodiment of the invention.

### DETAILED DESCRIPTION

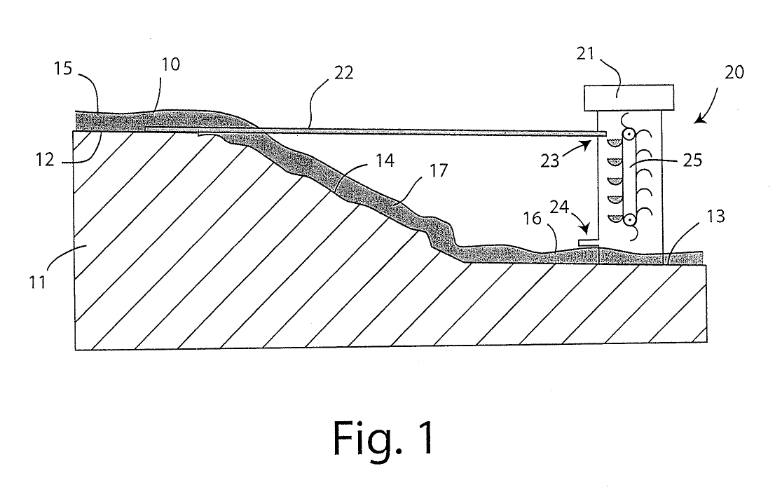

A first exemplary embodiment of the invention is shown in FIGS. 1 to 3 of the accompanying drawings. FIG. 1 is a schematic cross-section of a geological formation 11, the upper surface of which provides ground supporting a river 10 serving as a renewable supply of water. The level of the ground decreases in height from a higher region 12 to a lower region 13 via a sloped region 14. The river 10 consequently has a region 15 that is elevated relative to the ground within the lower region 13, and has a lower region 16 and rapids 17 following the sloped region 14 of the ground.

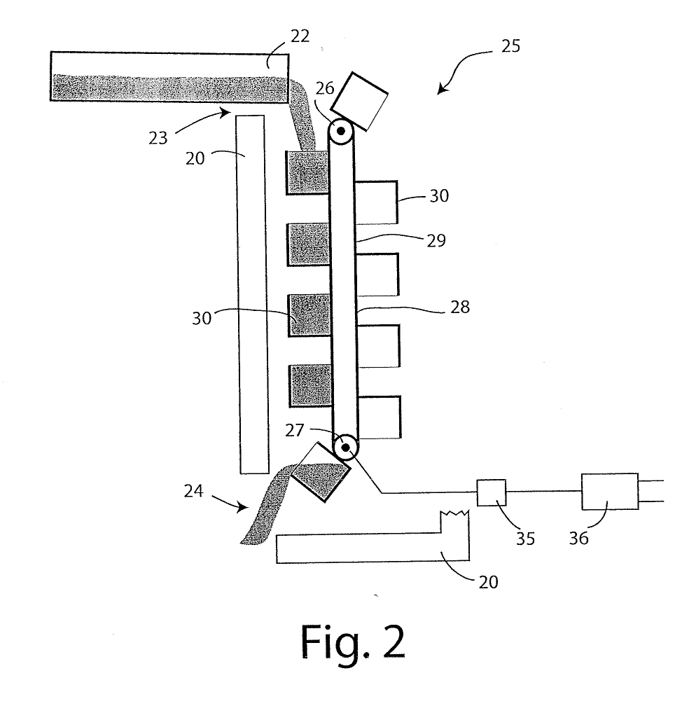

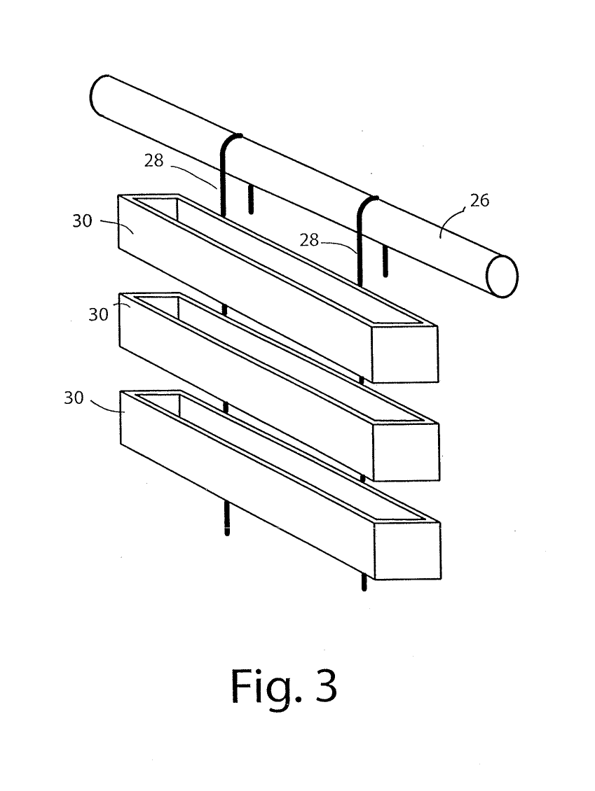

An apparatus for generating power is provided close to the river. The apparatus includes an upstanding structure 20 supported on the ground adjacent to the river at the lower region 13 of the ground. In this exemplary embodiment, the structure is in the form of an enclosed silo-like building made of strong construction material, such as concrete or metal, but it could alternatively be a structure as simple as a upstanding post set firmly within the ground. The structure 20 has a top 21 at a level similar to or greater than the level of the elevated region 15 of the river. A conduit 22 for water extends from the elevated region 15 of the river to the structure 20 for delivery of water from the river to the structure. The conduit 22, which may be in the form of a closed pipeline or an open-topped channel, is generally horizontal or preferably slightly downwardly inclined towards the structure 20 to ensure an adequate and preferably continuous supply of water through the conduit. The entrance of the conduit 22 at the river end may be supported on the river bed itself and, if desired, may be provided with a filter to prevent entry of debris or other objects. At the opposite end, the conduit 22 enters the structure through a water inlet 23 and eventually leaves through a water outlet 24. However, if the upstanding structure is not an enclosing housing, e.g. it is a simple post, the water inlet would merely be a region where the water is delivered from the end of the conduit 22 and the water outlet would be a region where water is delivered to the lower region 13 of the ground to return eventually to the river 10. The water from the conduit 22 is supplied to a gravity-operated energy converter 25 shown in greater detail in FIGS. 2 and 3. The converter 25 of this exemplary embodiment includes an upper generally horizontal rotatable shaft 26 and a lower generally horizontal rotatable shaft 27, the lower shaft 27 being aligned with and positioned at a distance directly vertically below the upper shaft 26. Both shafts are supported within bearings (not shown) that are, in turn, supported by the upstanding structure 20. Two flexible chains 28 act as endless flexible members passing around and between the shafts 26 and 27 in vertical loops 29. The chains engage sprocket wheels (not shown) mounted on and keyed to the shafts 26 and 27 so that the teeth of the sprocket wheels positively engage the links of the chains provided with holes of size and shape corresponding to those of the teeth. Accordingly, rotation of the loops 29 causes positive rotation of the shafts 26 and 27. The chains 28 securely support a plurality of water containers 30 in the form of elongated rectangular boxes. The containers 30, which may be made of metal, wood, plastics or other suitable materials, are held in a generally horizontal orientation and are supported at generally equally spaced intervals along the chains 28 so that they move with the chains. The containers are open along one long face such that, the open faces all face upwardly and form the tops of the containers on one vertical side of the loops 29 formed by the chains (the “fill-side” or “downward side”) and face downwardly at the bottoms of the containers on the opposite vertical side (the “empty-side” or “upward side”).

Therefore, as shown in FIG. 2, river water from the conduit 22 entering the structure 20 at the elevated water inlet 23 pours into the uppermost container 30 on the fill-side of the loop 29 through the open face at the top of the container. The weight of the water in the container causes the container to descend vertically, thereby rotating the loops 29 in an anti-clockwise direction, and causes another container 30 from the empty-side of the loops 29 to rotate into position adjacent to the inlet 23 for filling with water. At the lower end of the energy converter 25, a lowermost container 30 is emptied into lower water outlet 24 as it tilts and rotates under the lower shaft 27, as shown in FIG. 2. A container 30 emptied in this way rotates to the vertical empty-side of the loops 29 and ascends towards the top of the energy converter as the loops continue to rotate. The weight of water in the containers 30 is therefore all carried on one side of the loops 29 formed by the chains 28, and this causes the loops to rotate continuously as long as river water is available at the inlet 23 to fill the containers. The containers thus form movable elements that engage the water and cause the water to descend vertically while utilizing the weight of the water to rotate the loops. The water leaving the lower outlet 24 is channelled back to the river at the lower region 16 (FIG. 1).

The lower rotatable shaft 27 is mechanically connected to a gearbox 35, and an output shaft of the gearbox is connected to a generator of electricity 36 as shown schematically in FIG. 2. The gearbox changes the speed of rotation produced at the driven shaft relative to that at the output of the gearbox according to a fixed ratio. Generally, the gearbox increases the speed of rotation for better suitability for generation of electricity by the generator 36. The gearbox 35 and the generator 36 slow the descent of the water-filled containers 30 so that an excessive speed of descent is avoided. This form of speed control also allows each container 30 to be filled substantially completely before another container from the empty-side of the loop rotates into position. Therefore, even if the rate of flow of water from the river is quite slow, the containers 30 can be substantially filled to produce a significant weight for rotation of the chains 28 and the shafts 26 and 27.

It will be seen that, in this exemplary embodiment, use is made only of the weight of the water in the containers 30 which descend vertically under the effects of gravity between the horizontal levels of the inlet 24 and the outlet 24. The containers 30 form movable elements that convert the potential energy of the water into kinetic energy to rotate the shafts 26 and 27 and thereby operate the generator 36 to produce electricity. There is no attempt to provide or make use of sideways momentum of the water, thus avoiding sloping runs or arced paths of descent, and the vertical descent of the water under gravity is alone used to generate the energy. Consequently, the output of the energy converter 25 remains much the same regardless of the rate of flow of water in the river 10 and the conduit 22, so there is little change of energy output between wet and dry seasons provided the quantity of water in the river remains above a certain minimum, i.e. sufficient for delivery along the conduit 22 for filling of the containers 30.

The vertical separation of the shafts 26 and 27, and thus the height of the energy converter 25 and the supporting structure 20, may vary to suit particular environments, and the vertical separation generally dictated by the fall in vertical level of the river. Clearly, the water inlet 23 should be no higher than the surface of the river water in the elevated region 15, or water will not flow under gravity to the structure 20. However, the inlet 23 should be as high as possible (consistent with reliable water flow through the conduit 22) so that a maximum distance of fall is available for the containers 30. The sizes of the containers 30 may also be determined by particular environments, e.g. they should take into account the flow of water at the inlet 23, and should be large enough to be filled substantially completely while avoiding undue spillage caused by overfilling, thereby ideally using 100% of the water diverted from the river for energy generation. As a particular example, the containers 30 may be generally rectangular as shown in FIGS. 2 and 3 with a length of about 15 feet, and a depth and width of about 3 feet in each case (thereby making each capable of holding 135 cubic feet of water weighing approximately four tons). Of course, the containers 30 do not have to be rectangular, and may be of any other suitable shape, e.g. U-shaped in transverse cross-section as shown in FIG. 1.

To obtain a suitable difference in vertical height, it may be necessary, e.g. in gently descending terrain, to make the conduit 22 quite long, in which case suitable intermediate supports (not shown) would be provided. However, since the water descends under gravity and the conduit may be made of inexpensive materials, such increased lengths will not add significantly to the capital or operational costs of the apparatus. It is therefore not necessary to provide the structure 20 directly adjacent to rapids or a water fall or the like, although this may be preferred.

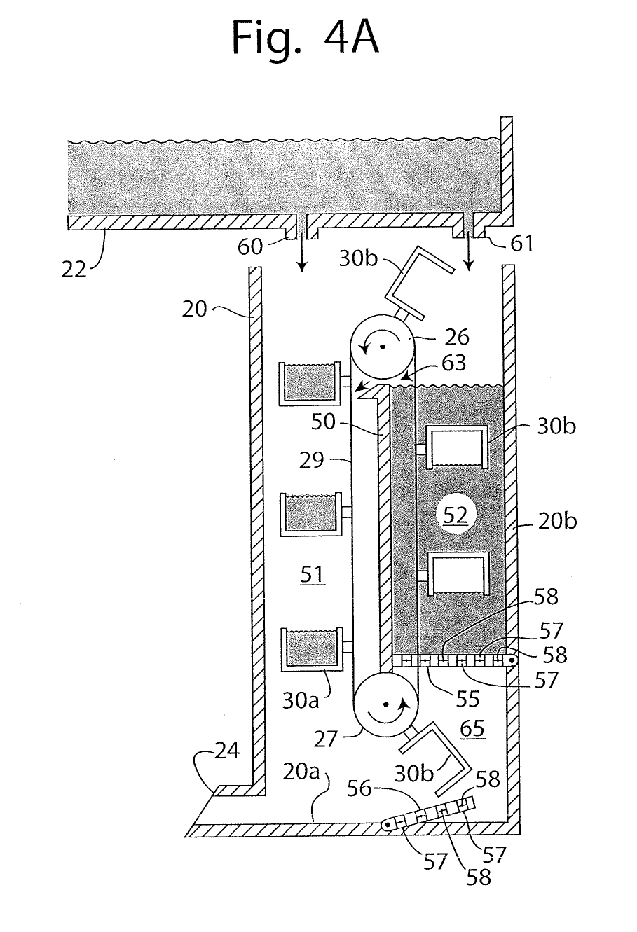

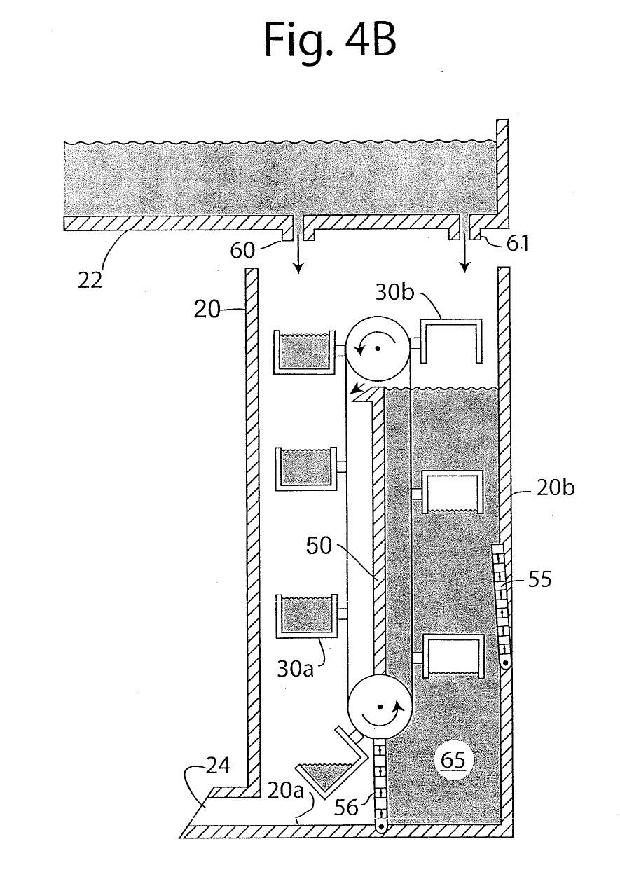

A modification of the embodiment above is shown in FIGS. 4A and 4B. In this exemplary embodiment, the upstanding structure 20 has an internal divider wall 50 dividing the interior into two vertical passageways, i.e. a first vertical passageway 51 for receiving the fill-side of the loops 29 and filled containers 30a, and a second vertical passageway 52 for receiving the empty-side of the loops 29 and the empty containers 30b. The second vertical passageway 52 is open at the top so that the empty containers 30b may leave the second vertical passageway, pass over the upper shaft 26 and invert themselves in doing ready for filling with water in the first vertical passageway 51. At its upper end, the internal divider wall terminates a short distance below the upper shaft 26, and at its lower end the internal divider wall 50 terminates immediately above the lower rotatable shaft 27, at least in a region between the loops 29, so that filled containers 30a, which tilt and empty in the process, may pass around and under the lower shaft 27 and invert themselves in doing so to prepare them for ascent within the second vertical passageway 52. The lower end of the internal divider wall 50 is sealed against the outer surface of the lower shaft 27, e.g. by means of an intervening elastomeric seal (not shown) provided at the lower end of the wall. Horizontally beyond the ends of the lower shaft 27, the internal divider wall 50 descends to the bottom wall 20a of the structure 20 and provides a water-tight seal in this region. The wall is also sealed against the ends of the lower shaft 27 (or the bearings supporting the shaft) to prevent loss of water at these positions, and indeed the internal divider wall may support the lower shaft at its ends. The second vertical passageway 52 is provided with a first movable dam 55 pivoted at one lateral edge to the sidewall 20b of the structure 20 and movable between a first position (as shown in FIG. 4A) extending across the second vertical passageway 52, and a second position (as shown in FIG. 4B) pivoted upwardly to avoid blocking the second vertical passageway 52. The structure 20 is also provided with a second movable dam 56 pivoted on the bottom wall 20a of the structure and movable between a first position (as shown in FIG. 4A) pivoted generally parallel to the bottom wall 20a, and a second position (as shown in FIG. 4B) in which it is vertical and effectively forms a lower extension of the internal divider wall 50 blocking the lower end of the second vertical passageway 52 against loss of water to the water outlet 24 of the structure.

The conduit 22 in this exemplary embodiment extends fully across the top of the structure 20 and is provided with two outlets for water, i.e. a first water outlet 60 positioned directly above the first of the containers in the first vertical passageway 51 on the fill-side of the loops 29, and a second outlet 61 positioned above the second vertical passageway 52. The first water outlet 61 operates to provide water to fill containers 30a in the first vertical passageway 51 in the same manner as in the embodiment of FIGS. 1-3. The second water outlet 61 operates to introduce water into the second vertical passageway 52 to fill the passageway up to a maximum level dictated by an overflow outlet 63 formed in the internal divider wall 50 immediately below the upper shaft 26. Any excess water flowing through the second water outlet 61 is diverted into the first vertical passageway 51 for use in filling the containers 30a in that passageway. The second vertical passageway 52 may be filled with water from the very bottom adjacent to the bottom wall 20a of the structure 20 when the first movable dam 55 is raised and the second movable dam 56 is also raised as shown in FIG. 4B. However, the second movable dam 56, when in this position, prevents the movement of containers 30a under the lower horizontal shaft 27 and into the second vertical passageway 52 as will be apparent from FIG. 4B. Therefore, to permit such movement, the first movable dam 55 is pivoted from its upright position to a horizontal position extending across the second vertical passageway 52 to prevent complete loss of water from the second vertical passageway. When the first movable dam 55 is in this position, the second movable dam 56 may be pivoted to a generally horizontal position as shown in FIG. 4A, which allows water in a space 65 below the first movable dam 55 to drain to and through outlet 24 and makes it possible for a newly-emptied container 30b to enter the space 65 as shown in FIG. 4A. The water in the second vertical column 52 is held in place by the first movable dam 55, so that only the water previously contained in the space 65 is drained from the second vertical passageway 52. The second movable dam 56 may then be pivoted once again to the upright position and the first movable dam 55 also pivoted to the upright position to allow the container 30b in space 65 to continue to rise within the second vertical passageway 52 as shown in FIG. 4B. Water introduced into the second vertical passageway 52 via the outlet 61 of conduit 22 compensates for water previously drained from space 65 to maintain the maximum depth of water in the passageway. This procedure is repeated each time a container 30a from the first vertical passageway 51 is ready to pass beneath the lower rotatable shaft 27.

The movements of the movable dams 55 and 56 are facilitated by providing them with elongated slots 57 that are closable by rotatable elongated blades 58 held within the slots and provided with rotatable bearings (not shown) at their respective longitudinal ends. The blades 58 act as valves that either prevent passage of water through the slots 57, when rotated to extend fully across the slots 57 to block the slots, or to allow passage of water through the slots when rotated to unblock the slots 57. In the operations previously described, the blades 58 in the second movable dam 56 are rotated to the blocking position before the second movable dam is pivoted from the horizontal position to the upright position to prevent loss of water from the space 65 when it is filled, but the blades 58 are rotated to the unblocked position just before the second movable dam 56 is rotated from the upright position to the generally horizontal position thereby allowing drainage of water from the space 65 through the slots 57 in the second movable dam. This prevents a cascade of water flowing over the top of the second movable dam 56, and reduces the pressure on the dam that would otherwise resists its pivotal motion to its generally horizontal position. Similarly, the blades 58 in the first movable dam 55 are rotated to the unblocked position as the second movable dam is pivoted from its generally upright position to its horizontal position extending across the second vertical passageway 52. This allows the second dam to flow easily through the water in the second vertical passageway 52 from one position to the other because water can flow easily through slots 57 in the dam. When the second movable dam 56 is in its horizontal position, the blades 58 are then moved to the blocking position closing the slots 57 so that, when water is released from the space 65 beneath the first movable dam 55, the first movable dam supports the column of water above it without drainage of water into the space 65. Once an empty container 30b is positioned within the space 65, and the second movable dam is moved to the vertical position, the blades 58 in the first movable dam 55 are then rotated to the unblocked position so that water flows through the slots 57 in the first movable dam to fill the space 65. The first movable dam 55 can then be rotated through the water to its upright position to allow upward passage of the container 30b. The rotation of the blades 58 may be driven by electric, pneumatic or hydraulic motors (not shown) connected to the ends of the blades. The pivoting of the first and second movable dams 55 and 56 may also be effected by additional electric, pneumatic or hydraulic motors (not shown) connected to the first and second movable dams. The sequence of operations of the rotations of the blades and the pivoting of the dams may be under computer numeric control, e.g. by means of a programmable logic controller (not shown), to automate and coordinate the required operations.

Although the first and second movable dams 55 and 56 have been shown in this exemplary embodiment as located entirely within the structure 20 and as pivoting from a side wall or bottom wall of structure 20, the dams may instead be arranged to pass through slots of corresponding size in the respective side wall or bottom wall of the structure and caused to move either horizontally (in the case of the first movable dam 55) or vertically (in the case of the second movable dam 56) into and out of the second vertical passageway 52 to thereby enter and block the passageway, or alternatively to move through the slot and out of the passageway to allow suitable clearance for movement of a container 30a or 30b. Such an arrangement reduces the extent of movement required of a container around the loops 29 to clear the respective dams before the dams can again be moved. This makes it possible to provide the loops 29 with more containers 30 since the containers do not have to be so widely separated. It may also make it possible in this case to reduce the volume of the space 65 beneath the first movable dam 55, and thereby reduce the loss of water from the second vertical passageway 52 during each cycle of operation of the dams.

Whichever way of operating the dams is employed, it may be advantageous to cause the loops 29 to operate in a stop-go fashion rather than allow a smooth and continuous rotation of the loops and containers. This is because the rotation of the loops 29 may be stopped to allow proper movement of the first and second movable dams 55 and 56 before a newly emptied container 30b enters the space 65, and also again before the space 65 is filled with water and the first movable dam 55 is moved out of the way of ascent of the container 30b through the second vertical passageway 52. Time may also be taken to refill the second vertical passageway 52 to the maximum level following the introduction of water into the space 65. To provide for such stop-go motion of the loops and containers, brakes (not shown) selectively preventing or permitting rotation of the upper rotatable shaft 26 or the lower rotatable shaft 27, or both, may be provided. Such brakes may also be under computer numerical control to operate automatically and in concert with the opening and closing of the first and second movable dams 55 and 56, and the blades 58 within the slots 57 of those dams.

The advantage of the embodiments shown in FIGS. 4A and 4B and described above is that not only do containers 30a provide a turning force on one or both shafts 26 and 27 as the containers 30a descend through the first vertical passageway 51 under the weight of water held within the containers, but inverted empty containers 30b also exert an upward buoyancy force as they move upwardly through the second vertical passageway 52. This buoyancy force is created because the second vertical passageway is filled with water and the containers 30b, by virtue of their inverted orientations with the open face at the bottom, are full of air as shown in FIGS. 4A and 4B. The buoyancy force increases the rotational force on the shafts 26 and 27, possibly even doubling such force, and increases the electrical power that can be generated by the apparatus.

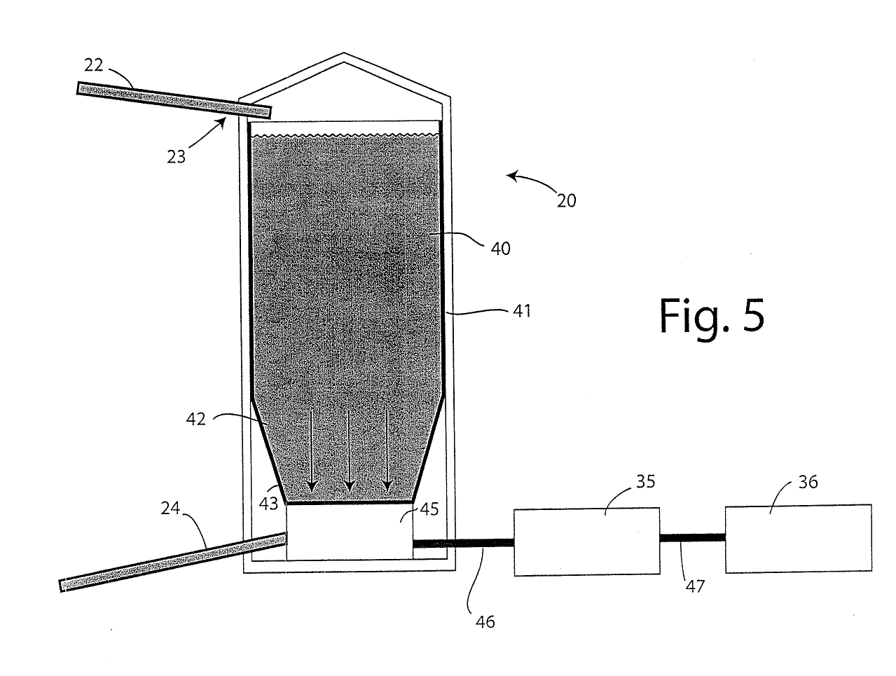

A further exemplary embodiment of the invention is shown in FIG. 5 of the accompanying drawings. In this embodiment, upstanding structure 20 houses a water tank 40. Conduit 22, as in the previous embodiments, supplies river water to a water inlet 23 where the water enters the tank 40. The tank wall 41 is generally cylindrical at the top, but has a lower section 42 that is tapered inwardly and downwardly to consolidate the weight of the water and to provide a lower tank outlet 43 of reduced size compared to the diameter of the tank at the top. The lower tank outlet 43 feeds water from the tank directly into a hydraulic motor 45 containing a moving element (not shown) such as a rotor or turbine that is rotated by the weight (pressure) of water from the tank 40. As shown schematically, a mechanical output from the hydraulic motor (e.g. a rotating shaft 46) is connected to a gear box 35 to speed up the revolutions and, in turn, an output from the gearbox (e.g. rotating shaft 47) is connected to an electrical generator 36 for generation of electricity. Spent water from the hydraulic motor 45 is channeled through the lower water outlet 24 and then to back to the river. Again, in this embodiment, it is the weight of water, i.e. water descending vertically, that creates the force required to drive the motor 45 and no attempt is made to use horizontal components of flow or sideways momentum of the water from the river. The weight of the water as it descends through the tank causes the movable element (e.g. the rotor) in the hydraulic motor to rotate and generate power, in this case in the form of electricity.

In this embodiment, the upstanding structure 20 may be a custom built building designed for support and stabilization of the water tank 40 bearing in mind the considerable weight of such a tank when filled with water.

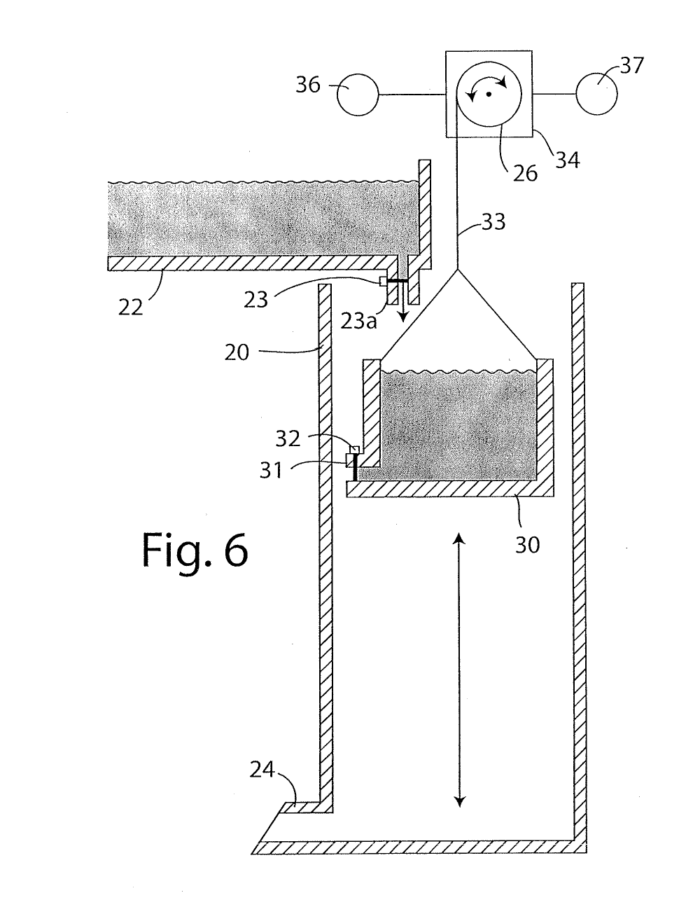

In yet another exemplary embodiment, as shown in FIG. 6 of the accompanying drawings, use is made of a gravity-operated energy converter that resembles an elevator. In this case, there is a single water container 30 that descends or ascends vertically as shown by the double-headed arrow. The water container 30 has an open top and is filled with water from conduit 22 via water outlet 60 which has a closable valve 60a. The container 30 has a lower outlet 31 provided with a closable valve 32 so that water may be held within the container or allowed to drain from it. The container 30 is supported by one or more flexible members 33, e.g. steel ropes, that are attached to and wound around an upper horizontal rotatable shaft 26. The shaft has a braking system 34 that selectively holds the container in place, or allows the container to descend or ascend, and is also operatively attached to an electrical generator 36 and to an electrical motor 38. As the container is filled with water at its uppermost position as shown in FIG. 6, it is held against descent by the braking system 34 until the container is full and, at that time, the valve 60a in the water outlet 60 is operated to terminate the flow of water into the container. The braking system 34 is then released to allow the container to descend under the effects of gravity and, while doing so, the flexible member 33 causes the shaft 27 to turn. The shaft 27 is at this time operatively connected to the electrical generator 36 via a gearbox (not shown), and the generator produces electricity. When the container 30 reaches its lowermost position, the valve 32 in a water outlet 31 is opened to allow water to flow out of the container to the outlet 24 of the structure 20. When the container is empty, the valve 32 is closed, and the container is hoisted to its uppermost position by electric motor 38 operatively attached to the shaft 27. The valve 60a in the water outlet 60 in the container is then opened, and the cycle is repeated. Since the weight of the empty container is much less than the weight of the container when full of water, the energy required to hoist the container to the uppermost position is much less than that generated as the container descends to the lowermost position, so there is a net gain of energy. This exemplary embodiment may be particularly useful when the flow of water through conduit 22 is fairly low or intermittent, since the container can be simply kept in its uppermost position until sufficient water has flowed through the outlet 23 to fill the container.

While particular embodiments of the invention have been illustrated and described, it would be clear to those skilled in the art that various other changes and modifications can be made without departing from the spirit and scope of the invention. It is therefore intended to cover in the appended claims all such changes and modifications that are within the scope of this invention.

1. Apparatus for generating power from a source of water, which comprises:
an upstanding structure adapted for support on ground adjacent to a renewable supply of water having an elevated region relative to said ground, said structure having a water inlet at a height no higher than said elevated region of the supply of water and a water outlet at a lower position than said inlet;
a conduit for water extending between said elevated region of said water supply and said water inlet; and
a gravity-operated energy converter supported by said structure that causes water to descend vertically between said inlet and said outlet while utilizing weight of said water to drive at least one movable element and thereby generate power.

2. The apparatus of claim 1, wherein said at least one movable element is operationally connected to a generator of electricity adapted to convert movement of said at least one movable element to electrical energy.

3. (canceled)

4. The apparatus of claim 1, wherein said gravity-operated energy converter includes an upper generally horizontal rotatable shaft, a lower generally horizontal rotatable shaft positioned at a distance vertically below said upper shaft, at least one endless flexible member passing around and between said shafts, and a plurality of water containers supported at intervals along said at least one flexible member, each water container having an open end orientated to receive water from said conduit at said water inlet and to release water from said container at said outlet, said containers acting as said at least one movable element.

5. The apparatus of claim 4, wherein said gravity-operated energy converter comprises at least two endless flexible members, each of said plurality of containers being supported by said at least two flexible members.

6. The apparatus of claim 4, wherein the or each of said at least one flexible member is an endless flexible chain engaging a sprocket wheel fixed on each of said upper and lower generally horizontal rotatable shafts.

7. The apparatus of claim 4, wherein said water containers are elongated boxes that are held generally horizontal by said at least one flexible member, said open ends of said containers being at the tops of said boxes on one side of a vertical loop formed by said at least one flexible member, and at the bottom of said boxes on an opposite side of said loop.

8. (canceled)

9. The apparatus of claim 4, comprising a vertical passageway extending between said lower generally horizontal rotatable shaft and said upper generally horizontal rotatable shaft and positioned to receive said plurality of containers as said containers rise vertically between said outlet and said inlet after said water has been released therefrom, means for introducing water from said elevated region of said supply of water into said passageway to cause said passageway to contain a column of water, a first movable dam near a bottom end of said passageway releasably sealing water within said passageway above said first movable dam, a second movable dam below said first movable dam releasably sealing water within said passageway, and means for selectively opening and closing said dams in a sequence to permit said containers to enter said passageway with only limited and intermittent loss of water from said passageway, and to rise in said column of water held within said passageway and generate upwardly-directed buoyancy forces due to air trapped within said containers.

10. The apparatus of claim 9, wherein at least one of said first and second dams pivots between an open position allowing a container to pass the dam and a closed position sealing water within said passageway.

11. The apparatus of claim 9, wherein at least one of said first and second dams moves transversely of the passageway between an open position allowing a container to pass the dam and a closed position sealing water within said passageway.

12. (canceled)

13. The apparatus of claim 1, wherein said energy converter includes an upstanding water tank fed with water at a top thereof via said water inlet and feeding water at a bottom thereof to said water outlet, said energy converter including a hydraulic motor at or near the bottom of the tank, said at least one movable element comprising a rotor within said hydraulic motor driven by water passing through said hydraulic motor.

14. The apparatus of claim 1, wherein said energy converter comprises, as said movable element, a container for receiving water from said conduit via said inlet, and said energy converter further includes a support for said container permitting said container to move vertically between said inlet and said outlet, and means for emptying said container of water when said container is positioned adjacent to said outlet, and wherein said container is connected via said movable support to a generator of electricity as said container moves vertically under gravity from a position adjacent said inlet to a position adjacent said outlet, and said container is connected via said support to a motor for raising said container vertically against gravity from a position adjacent said outlet to a position adjacent said inlet.

15. (canceled)

16. (canceled)

17. (canceled)

18. (canceled)

19. A gravity-operated energy converter, comprising:
an upstanding structure that has a water inlet adjacent a top thereof and a water outlet adjacent a bottom thereof;
at least one movable element movable between said water inlet and said water outlet, said at least one movable element being positioned to engage water passing generally vertically under gravity from said inlet to said outlet and to move vertically under weight of said water; and
a power generator coupled with said at least one movable element to convert movement of said at least one movable element to usable power.

20. The energy converter of claim 19, wherein said power generator is a generator of electrical power.

21. (canceled)

22. The energy converter of claim 19, wherein said energy converter includes an upper generally horizontal rotatable shaft, a lower generally horizontal rotatable shaft positioned at a distance vertically below said upper shaft, at least one endless flexible member passing around said shafts and a plurality of water containers supported at intervals along said at least one member, each container having an open end orientated to receive water at said water inlet and to release water at said outlet, said containers acting as said at least one movable element.

23. The energy converter of claim 22, comprising a vertical passageway extending between said lower generally horizontal rotatable shaft and said upper generally horizontal rotatable shaft and positioned to receive said plurality of containers as said containers rise vertically between said outlet and said inlet after said water has been released therefrom, means for introducing water from said elevated region of said supply of water into said passageway to cause said passageway to contain a column of water, a first movable dam near a bottom end of said passageway releasably sealing water within said passageway above said first movable dam, a second movable dam below said first movable dam releasably sealing water within said passageway, and means for selectively opening and closing said dams in a sequence to permit said containers to enter said passageway with only limited and intermittent loss of water from said passageway, and to rise in said column of water held within said passageway and generate upwardly-directed buoyancy forces due to air trapped within said containers.

24. The energy converter of claim 23, wherein at least one of said first and second dams pivots between an open position allowing a container to pass the dam and a closed position sealing water within said passageway.

25. The energy converter of claim 23, wherein at least one of said first and second dams moves transversely of the passageway between an open position allowing a container to pass the dam and a closed position sealing water within said passageway.

26. (canceled)

27. The energy converter of claim 19, wherein said energy converter includes a water tank fed with water at a top thereof via said water inlet and feeding water at a bottom thereof to said water outlet, said energy converter including a hydraulic motor at or near the bottom of the tank, and said at least one movable element comprises a rotor within said hydraulic motor driven by water passing between through said motor.

28. The energy converter of claim 19, wherein said energy converter comprises, as said movable element, a container for receiving water from said conduit via said inlet, and said energy converter further includes a movable support for said container permitting said container to move vertically between said inlet and said outlet, and means for emptying said container of water when said container is positioned adjacent to said outlet, and wherein said container is connected via said movable support to a generator of electricity as said container moves vertically under gravity from a position adjacent said inlet to a position adjacent said outlet, and said container is connected via said movable support to a motor for raising said container vertically against gravity from a position adjacent said outlet to a position adjacent said inlet.

29. A method of generating power from a renewable supply of water having ground adjacent thereto and a region of said water supply elevated relative to said adjacent ground, which method comprises:
channeling water from said elevated region of said water supply to a position above said adjacent ground;
causing said water to descend generally vertically from said position above said ground to a lower position adjacent to said ground; and
utilizing weight of said water to drive at least one movable element as said water descends, thereby converting gravity-based power of said water to movement of said at least one movable element for power generation therefrom.
